(19) United States
(12) Patent Application Publication
(10) Pub. No.: US 2002/0143588 A1
(43) Pub. Date: Oct. 3, 2002

(54) Card system for immigration/emigration control and card for use in the system

(76) Inventors: Yoshihisa Ishigami, Yokohama (JP); Kiyotaka Kinoshita, Kawasaki (JP); Tomoki Kondo, Nagoya (JP)

Correspondence Address: STAAS & HALSEY LLP, 700 11TH STREET, NW, SUITE 500, WASHINGTON, DC, 20001, US

(21) Appl. No.: 10/103,567

(22) Filed: Mar. 22, 2002

(30) Foreign Application Priority Data
Apr. 3, 2001 (JP) 2001-104571

(51) Int. Cl. G06F 17/60

(52) U.S. Cl. 705/5

(57) ABSTRACT

For foreign travel, a person carries a card having functions such as a passport function, an airline ticket or ship ticket function, and a credit function (electronic settlement function for foreign travel), then the person can automatically use an airport/seaport general information system, go through security check, check-in for boarding an airplane or a ship, a departure inspection or entry inspection and customs formalities, and purchase an airline ticket or ship ticket, etc. with the use of this card.

### BACKGROUND OF THE INVENTION

The present invention relates to a card system for immigration/emigration control, for controlling the operations concerned with entry/departure of people into/from a country, and also relates to a card for use in this system.

For foreign travel, a person possesses a set of passport, airline ticket/ship ticket and departure card or entry card according to a need.

Under the current departure control, an immigration inspector for departure examines a person leaving the country, based on a pocketbook-type passport and a departure card on which predetermined matters are described beforehand and which are carried by that person, by manually performing all of necessary operations including confirmation of various matters (for example, passport number, issuing country and date, date of expiry, name, and height) described on the passport and departure card, judgment of the propriety of the description, verification of genuineness of a picture attached to the passport, i.e., whether the person in the picture is identical with the person carrying the passport (for example, by means of password or biometric authentication based on finger print/palm print), and confirmation as to whether that person is not a person who is prohibited to leave the country. Almost the same operations as for departure are carried out for entry into the country.

In addition, since the material of the current passports is paper, the current passports have problems that various matters printed on the passport about the bearer are easily rewritable and the rewritten passport is readily used as a forged passport, and the current passports may be burnt at the time of accident, such as an airplane accident, which makes it difficult to identify the person bearing the passport.

It has been known that an airline ticket is separated through a cutting line into a boarding pass to be held by the passenger and a withdrawal ticket that is to be collected by the airline at the boarding gate to the airplane. All or part of the boarding information, such as the name of airline, flight number, name of departing airport, name of arriving airport, place of transition, fare, name of passenger, seat number, seat class and seat feature, is visibly printed on the front side of each of the withdrawal ticket and the boarding pass, while a sequence of magnetic stripes (MS data) is formed on the back side of the airline ticket. When a user makes a request for reservation of a flight at a branch of an airline or a travel agency, the information described in the request form by the user is inputted and communicated with a seat reservation system of the head office of the airline via a communication line to confirm the reservation of the airline ticket. When the reservation has been confirmed, the airline ticket is issued based on the ticketing data notified by the seat reservation system. At this time, the boarding information is visibly printed, and the MS data is recorded.

At a predetermined time before the boarding time, the passenger submits the airline ticket to the airline's check-in counter in the airport, and the airline staff reads the boarding information from the magnetic stripes on the airline ticket with a check-in confirmation machine so as to confirm the reservation with respect to the seat reservation system. When the confirmation has been made finally, the staff returns the airline ticket to the passenger. At the boarding time, the passenger hands the airline ticket to the airline stuff at the boarding gate. The stuff inserts this airline ticket into a boarding confirmation machine to read the boarding information of the magnetic stripes and collate it with the boarding information (data for confirmation) read by the check-in machine for the confirmation of boarding. Then, when the confirmation of boarding has been completed, the airline ticket is cut along the cutting line, the boarding pass is passed to the passenger, and the withdrawal ticket is collected. The passenger boards the airplane with this boarding pass and sits on a seat according to the seat number printed on the boarding pass.

By the way, a super jumbo airplane (with a capacity of around 700 people) will be placed in an international line in 2005. In order to prevent crowdedness in processing a large number of passengers, cargo, baggage on this super jumbo airplane and CIQ (customs, immigration and quarantine) inspection procedures, it is necessary to entirely review the functional facilities of the passenger terminal buildings. However, it would take a lot of time and cost to execute the plans for rebuilding, expanding and maintaining the individual passenger terminal buildings. Hence, there is a need to immediately start reviewing necessary fundamental conditions for a plan of a standard individual/exclusive terminal that is irrelevant to existing facilities and can be applied to any airport, otherwise time is running out.

In addition, according to an outlook of new shipbuilding demands for OECD new large passenger ships, there will be a gradual increase in the demands for very large deluxe passenger ships (with a capacity of not less than 1,000 people) which will be engaged with around-the-world services in the twenty first century. Accordingly, it comes to the period of newly building/rebuilding not only international airport terminals, but also seaport terminal facilities in large seaports. However, like the passenger terminal facilities of the international airports, since the current seaport terminal facilities can not handle a large number of passengers and baggage, there is a possibility that long-time waiting, congestion and disorders will be caused in embarking/disembarking, and safety and security control countermeasures may suffer from problems.

### BRIEF SUMMARY OF THE INVENTION

An object of the present invention is to provide a card system for immigration/emigration control, capable of automatically performing immigration/emigration control operations and check-in operations at airports and seaports from/at which international lines depart and arrive and of rapidly and efficiently processing various kinds of immigration/emigration-related operations for a large number of passengers within the limited facility space, and to provide a card for use in this system.

In a card system for immigration/emigration control of the present invention, a person carries a card having a passport function, an airline ticket or ship ticket function, a credit function, in etc. for foreign travel, and the person can use an airport/seaport general information system, go through security check, check-in for boarding an airplane or a ship, a departure inspection or entry inspection and customs formalities with the use of this card.

According to the present invention, the passport function, airline ticket or ship ticket function, and credit function (electronic settlement function for foreign travel) are integrated into a single card. By reading/writing data in this card with a terminal device (reader/writer), the person can go through an immigration/emigration inspection, check-in for boarding an airplane or a ship and security check, and purchase an airline ticket or ship ticket, etc. As a result, checking or inspection information can be shared, checking operations which have been performed by people conventionally can be automated/performed with less people, and the space for the involving facilities is reduced.

For example, the person purchases a smart card as a credit card from a card issuing company in advance, and submits this smart card and an application when he/she applies for a passport. Data of the contents described on the passport is embedded in this smart card at the time of issuance of the passport, an image of a photograph of the person is loaded in the card, and thus the person obtains a smart passport card with a picture (a card of the present invention).

When the person purchases an airline ticket or ship ticket, matters necessary for performing the check-in operation, such as an airline (shipping company) to be used, destination, fare, seat (room) number on board and baggage number as well as the passenger number and identification data of the person, are written in the card of the present invention by a terminal device (reader/writer). Therefore, the operations at the check-in counters of airlines or shipping companies in the existing airport or seaport terminal buildings are simplified or abolished.

Regarding the airport facilities, in order to board a large number of passengers safely and surely, a boarding lobby as a waiting room is provided to prevent scattering movement of the passengers, and all the convenient functional service facilities are moved to this boarding lobby. Furthermore, in order to ensure exactness of the departure time and to prevent misrecognition of the passengers, the boarding lobby is arranged to have a floor area corresponding to at least two super jumbo airplanes (having a capacity of 1,400 people).

In the security check performed to prevent hijack before people enter the boarding lobby, the card of the present invention is inspected with the terminal device. At the inspection counter for departure and the checking counter at the boarding gate, after checking the check-in data inputted beforehand with the card of the present invention by using the terminal device, the verification of a person, the boarding seat number and the place of baggage are secured, and then the person gets on board. Moreover, filling in the departure card which is conventionally required can be omitted by using the card of the present invention.

Furthermore, by reading data written in the card of the present invention with the terminal device (reader/writer), the inspection for entry is simply performed. Filling in the entry card, which is conventionally required, can be omitted by automatically reading the entry card information contained in the information obtained from the card of the present invention.

In the EEPROM memory of the card of the present invention in which the information about the person is written, basic information determined as a fixed format and temporary area information which is utilized for the person's purpose are separately stored. The basic information is the passport-related information including photograph image data, authentic information for use in security check and other information given by official certificate issuing organizations, while the temporary area information is financial settlement-related information such as information about the bank account; travel-related support information such as the airline ticket, and other various kinds of information. Thus, such information is used conveniently.

The present invention connects a public organization server of an official certificate issuing organization such as the ministry of foreign affairs which has the basic ledger and original image log in files and issues passports, an external commercial server of a travel agency, a shop, an external inquiry center such as a bank, etc. which have the card inquiry, account settlement and time series details logs in files, and an airport or seaport terminal server having files of the management ledger in the airport or seaport terminal, check-in and immigration/emigration control together as a network, writes/reads data in the card of the present invention on the respective spots to provide card system security network authentication. Accordingly, authentication using the card of the present invention is readily performed on the network.

The card of the present invention also functions as a search card for searching for various kinds of guide information such as boarding or embarking guide. Thus, even when guide services at the check-in counter which are conventionally essential are omitted, the person can easily obtain a variety of necessary information from the terminal devices. As a result, the check-in operation at the check-in counter can be performed rapidly, the space can be saved, and a large number of passengers can be processed more rapidly and safely.

The card of the present invention also functions as a baggage inspection card. It is therefore possible to rapidly execute the baggage inspecting operation, and eliminate the need to carry the stub of the baggage tag.

The above and further objects and features of the invention will more fully be apparent from the following detailed description with accompanying drawings.

### BRIEF DESCRIPTION OF THE SEVERAL VIEWS OF THE DRAWINGS

FIG. 1 is an explanatory view of a card system for immigration/emigration control of the present invention in respect of departure;

FIG. 2 is an explanatory view of the card system for immigration/emigration control of the present invention in respect of entry;

FIG. 3 is an explanatory view of a network system of the card system for immigration/emigration control of the present invention;

FIG. 4 is an explanatory view of a card of the present invention;

FIG. 5 is an explanatory view showing a flow of processing the card of the present invention;

FIG. 6 is an explanatory view of a passenger terminal for departure when the card system for immigration/emigration control of the present invention is implemented; and

FIG. 7 is an explanatory view of the passenger terminal for entry when the card system for immigration/emigration control of the present invention is implemented.

### DETAILED DESCRIPTION OF THE INVENTION

The following description will explain the present invention in detail with reference to an embodiment thereof.

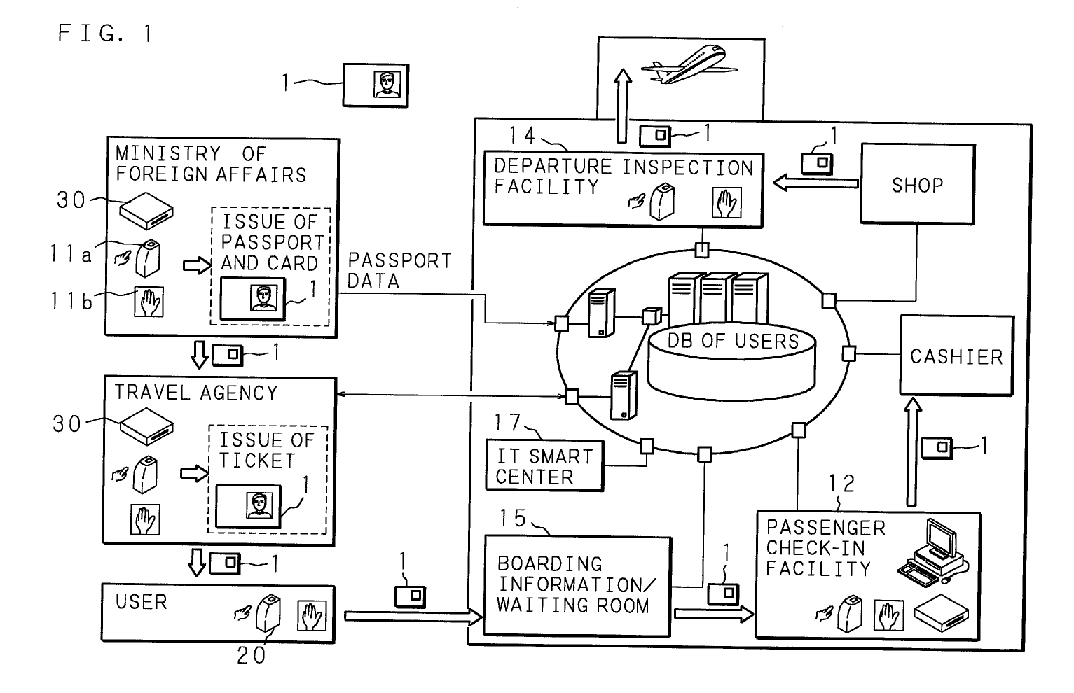

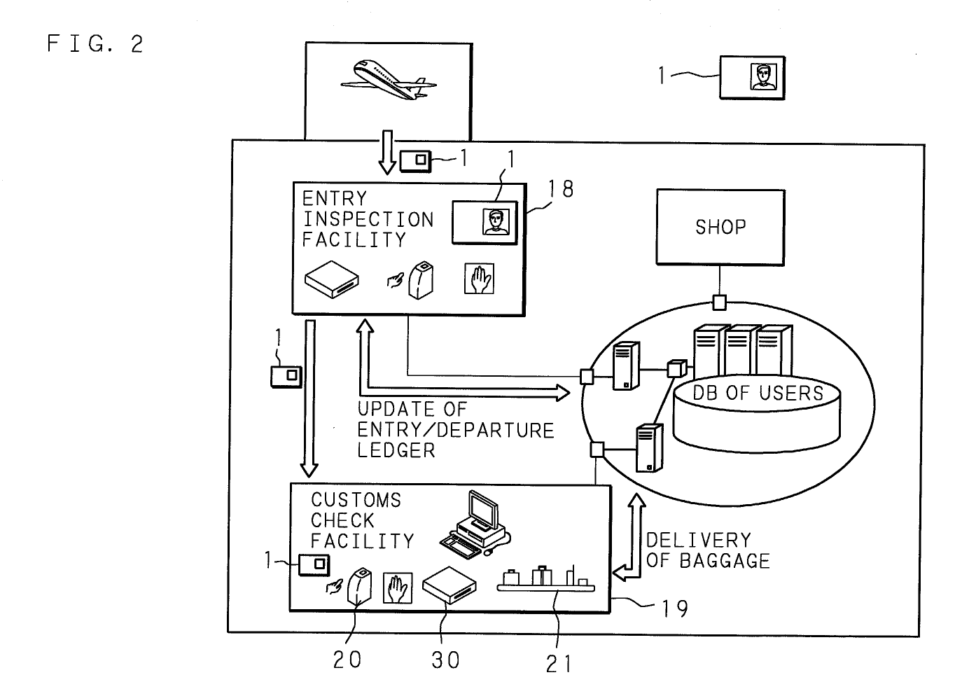

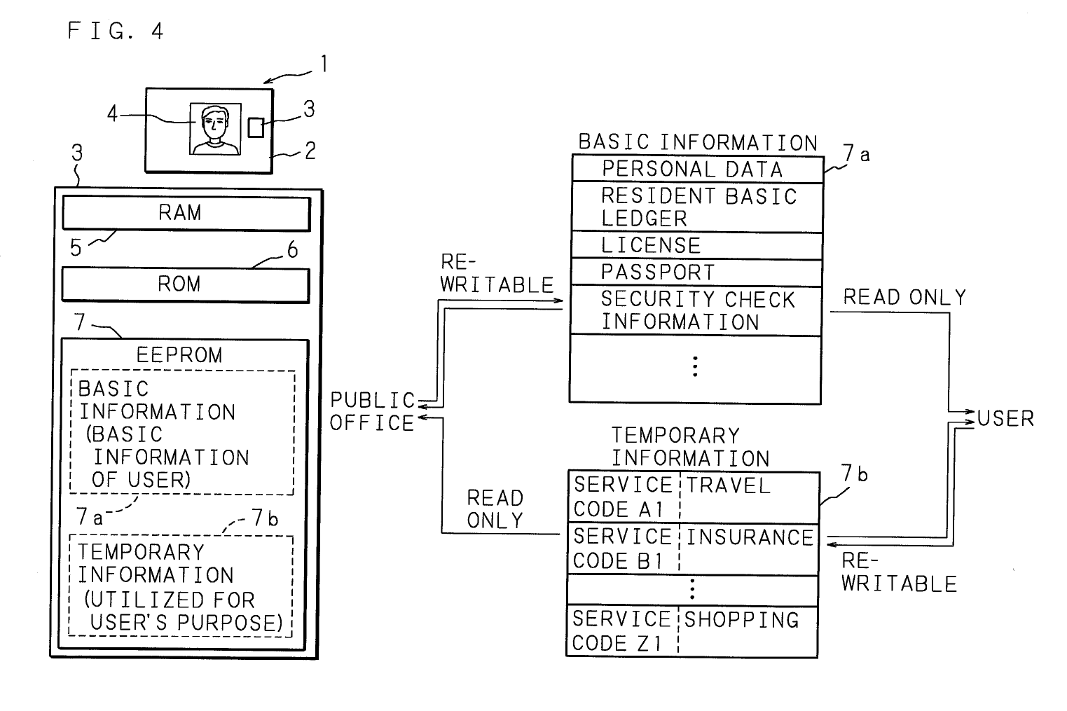

FIG. 1 is an explanatory view of a card system for immigration/emigration control in respect of departure and FIG. 2 is an explanatory view of the same card system in respect of entry, wherein numeral 1 is a smart passport card with a picture. As shown in FIG. 4, this smart passport card 1 with a picture (hereinafter simply referred to as the “passport card 1”) is an IC card having an IC memory chip 3 embedded in a card main body 2 and a photograph 4 of the upper half of body attached to its front side.

The contents of the IC memory chip 3 include a RAM 5 and a ROM 6 as memories used by the system, and an EEPROM memory 7 that is an area usable by a user. The EEPROM memory 7 is divided into an area for basic information 7a that is determined as a fixed format, and an area for temporary information 7b that can be utilized for the user's purpose.

The basic information 7a is living basic functional information, information issued by official certificate issuing organizations and other authentication-related information, such as passport-related information including the image data of a photograph of the upper half of body (same as the photograph 4), security check information (such as a password and a finger print/palm print), the resident basic ledger (resident identification card), the certificate of registered seal impression, national pension, long-term care insurance, driving license, health insurance card, national health insurance card, mutual aid association card, pension card, student card, identification card issued by a company, a copy of one's family register and an extract of one's family register. The passport-related information includes the term of validity of a ten-year passport or five-year passport, and the length of stay in the main destination. Furthermore, the basic information 7a includes basic data for biometric verification of a finger print, a palm print, etc.

On the other hand, the temporary information 7b is various kinds of information including: financial settlement-related information such as information about the bank account for providing the passport card 1 with an electronic settlement function for foreign travel; travel-related support information such as reservation of airline tickets and hotels; personal information such as insurances and information about employment; weather; and stock prices. As shown in FIG. 4, the temporary information 7b includes service codes, for example, A1 for travel, B1 for insurance, and Z1 for shopping, and each industry can determine the format of the data area for each service code and use the data area freely. Moreover, authentication and encipherment methods can also be determined freely by the industry.

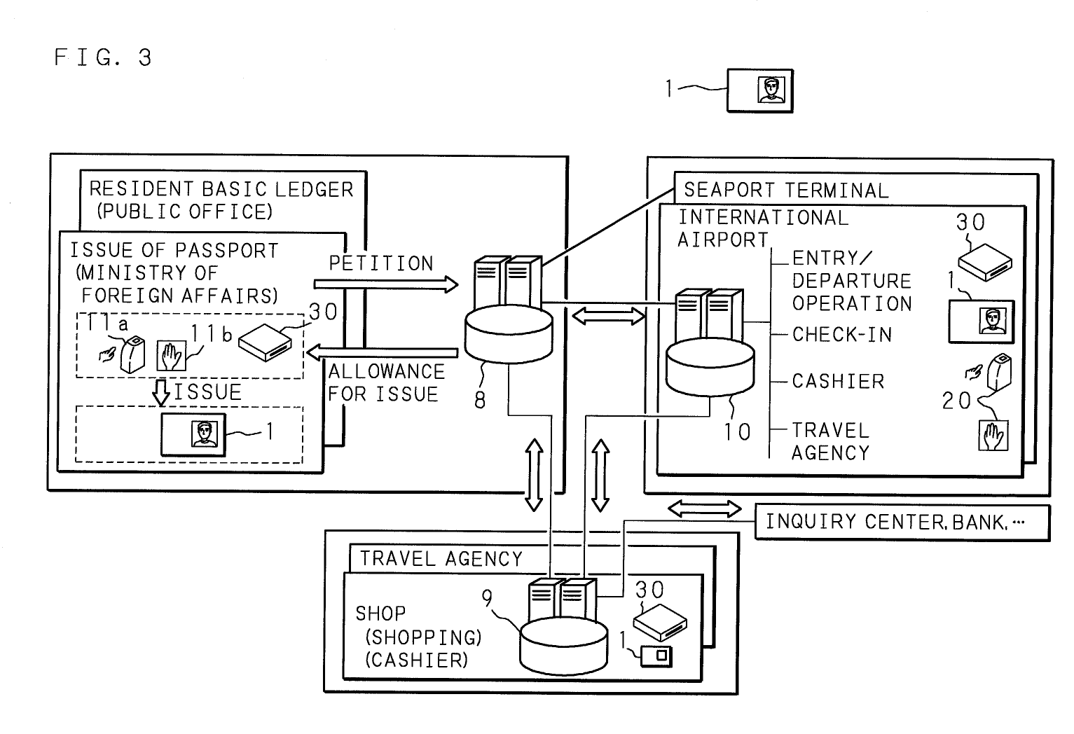

Next, referring to FIG. 3, the following description will explain a network system for the use of such a passport card 1. This network system comprises a public organization server 8 which is possessed by an official certificate issuing organization, such as the ministry of foreign affairs that has the basic ledger and original image logs as files and issues passports, and a public office that has the resident basic ledger; an external commercial server 9 of an airline, travel agency, shop and external inquiry center such as a bank, which has card inquiry, settlement process, time series details logs as files; and an airport/seaport terminal server 10 which has files of the management ledger in the airport or seaport terminal, check-in and immigration /emigration control. These public organization server 8, external commercial server 9 and airport/seaport terminal server 10 are connected together by a communication network such as the Internet, and terminal devices 30 as readers/writers for reading/writing data in the passport card 1 are connected to these servers on the respective spots to provide card system security network authentication. A face photograph capturing device (not shown), a finger print taking device 11a, a palm print taking device 11b, etc. are connected to the terminal device 30 of the public organization server 8.

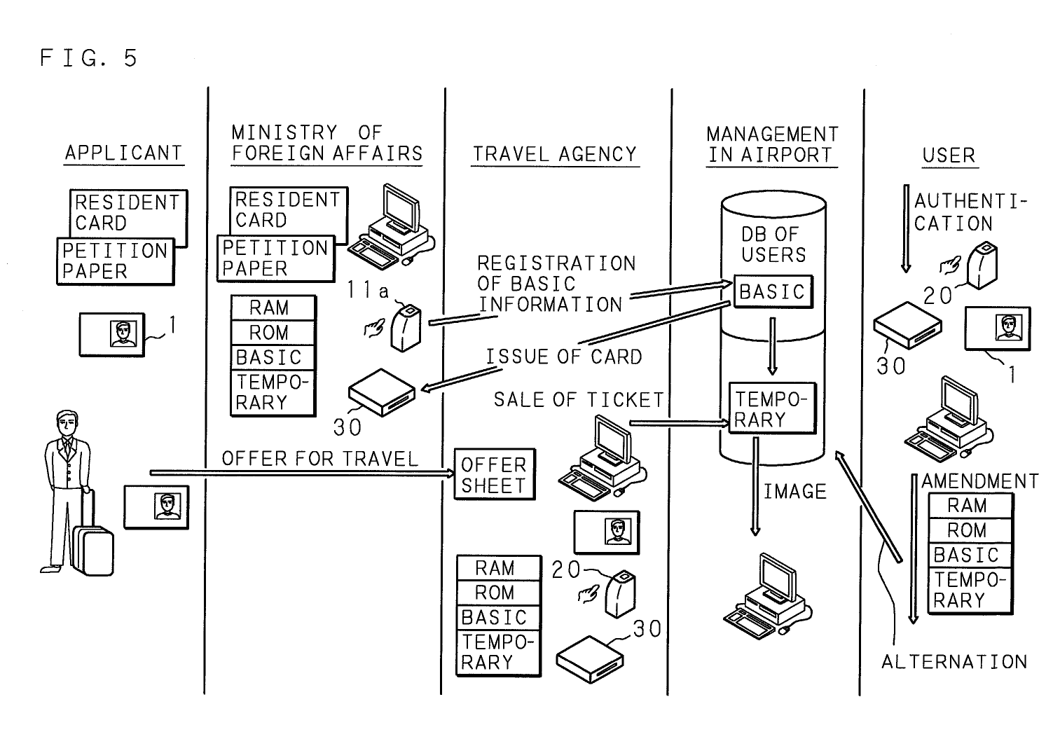

Referring to FIG. 5, the following description will explain the flow of processes of issuing a passport and purchasing an airline ticket or ship ticket using the passport card 1. The user purchases a smart card having an electronic settlement function from a card issuing company in advance, and submits this smart card and a petition paper when applying for a passport. During issuance of the passport, the data described on the passport, the person's identification data and photograph and/or finger print are contained in the smart card to make a passport card 1. Note that the passport issued by the ministry of foreign affairs may be issued to the applicant with a smart card enclosed, and the user receiving the smart card may ask a financial organization for authorization to validate or add the electronic transaction settlement function later.

The airline ticket and ship ticket are purchased by this passport card 1. Upon the purchase of the airline ticket and the ship ticket, necessary data is written in the passport card 1 at the travel agency, airline, shipping company who has services on a foreign route, kiosk, etc., instead of ticketing the airline ticket and ship ticket, so that the data necessary for the check-in operation, such as the airline and shipping company to be used, destination, fare and boarding/shipping seat number, is written as well as the passenger number and the person's identification data.

When the user directly visits a travel agency, airline or shipping company, the data of the purchased airline ticket/ship ticket is written in a standard format in the passport card 1 by using the terminal device 30 (I/O device) of that agency and so on [kiosk terminal]. The electronic transaction settlement function is added to the passport card 1. Tag RFID (Radio Frequency Identification) is also issued. RFID can be reissued by the terminal device 30, if it is lost.

For the purchase/reservation through a telephone, a facsimile or the Internet, if the user's PC (personal computer) has a terminal device 30 (I/O device), the airline ticket/ship ticket data is downloaded to the passport card 1. When the purchase/reservation is made through a telephone or when the PC has no terminal device 30 (I/O device), the purchased airline ticket/ship ticket data is downloaded to the passport card 1 later through a kiosk terminal.

The payment is made using the settlement function of a credit card or the passport card 1. When the user uses the settlement function, if the user's PC has a terminal device 30 (I/O device), then electronic money, a debit card and a credit card can be used. In other case, only a credit card can be used (payment is completed by just informing a seller of the card number).

When the ticket was purchased through a telephone, a facsimile or the Internet, the airline ticket/ship ticket data is downloaded through a kiosk terminal by the date of departure. The corresponding languages are the official languages of the United Nations. For example, the system may be designed to determine a corresponding language based on the nationality information contained in the basic information 7a of the passport card 1 or the nationality information contained in the customer information accessed by the server, and to download the airline ticket data in the determined language. The user who purchased the ticket at an agency and so on can also rewrite the data if there is some change. The verification of the person is made by the identification number or biometric characteristics. With the use of the passport card 1 in which the data is written, it is possible to monitor the movement of the person until he/she boards the airplane/ship by electronic waves. Therefore, the staff can promptly guide the passengers who have not yet on board at the last moment of departure to get on the airplane/ship.

Upon writing the data in the passport card 1, necessary pieces of RFID written in the standard format are issued. The flight/ship number, destination, etc. are written in RFID. Soon, RFID is issued at the travel agency, based on the data written in the passport card 1.

By just inserting the passport card 1 into the kiosk terminal, the unique information about the passenger, such as the airport/seaport information, is provided. However, when this function is provided, the length of time of using the kiosk terminal increases, and therefore the number of terminals to be placed needs to be taken into consideration. The kiosk terminals are placed at airport lobbies, seaport lobbies, railway stations, bus terminals, parking curbside, and also urban areas, etc. by considering the convenience of the users. In the airport lobbies, seaport lobbies, railway stations, bus terminals, etc., a kiosk terminal corner is arranged by placing a plurality of terminal devices 30 (I/O devices).

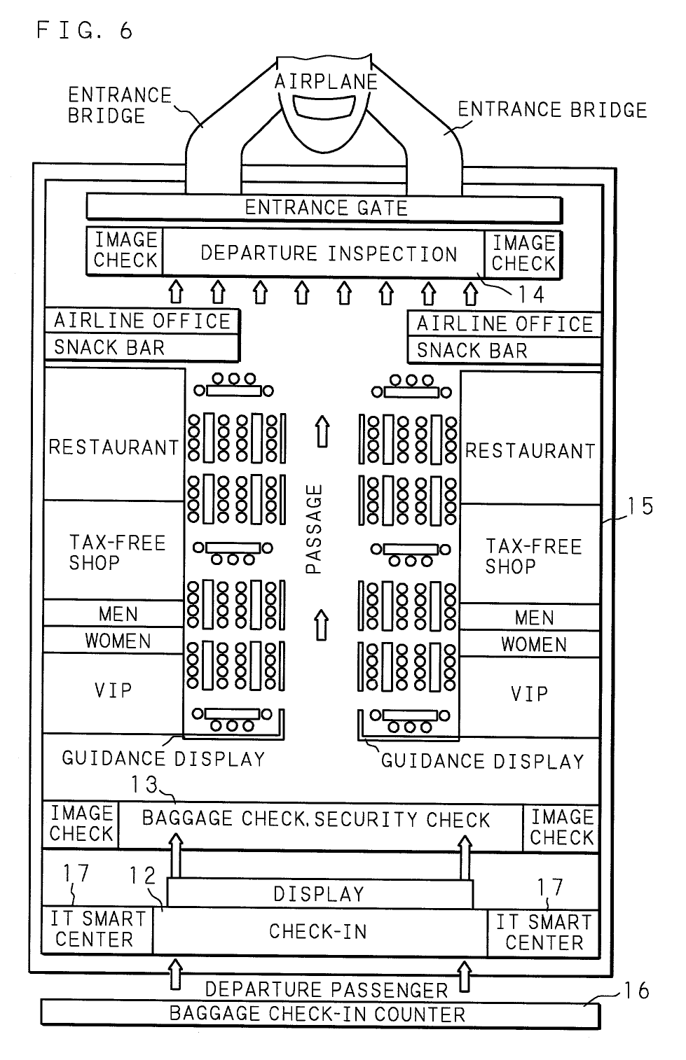

Next, the immigration/emigration control performed using such a passport card 1 will be explained. Prior to this, the facilities will be explained by referring to an airport passenger terminal as an example. In the airport passenger terminal, as the departure facilities, as shown in FIG. 6, a passenger check-in facility 12 for check-in, a security facility 13 for performing security inspections to prevent hijack, and a departure inspection facility 14 are present, and a boarding information/waiting room 15 is arranged between the security facility 13 and the departure inspection facility 14. Note that a baggage check-in facility 16 is located in front of the entrance of the airport passenger terminal building, such as the curbside and parking space. Moreover, in front of the security facility 13, a lobby called “IT general information smart center” 17 is arranged along with the passenger check-in facility 12, to provide various kinds of general information.

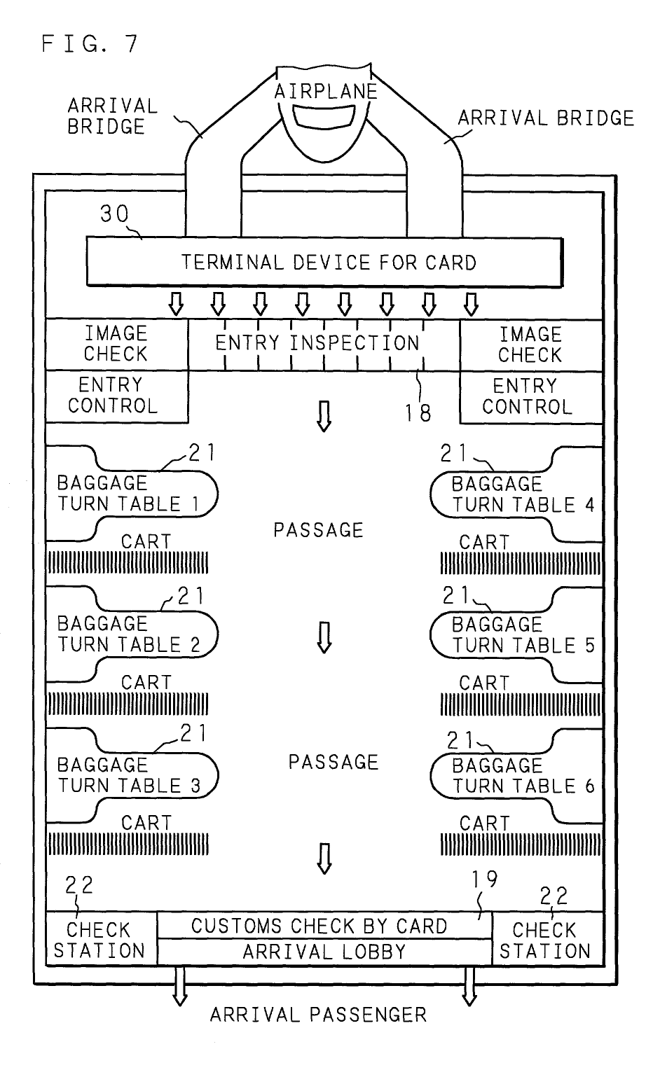

On the other hand, as the entry facilities, as shown in FIG. 7, an entry inspection facility 18 and a customs check facility 19 are present, and the terminal devices 30 that can be used with a passport card 1 are placed in front of the entry inspection facility 18.

The user brings his/her passport and passport card 1 when leaving his/her house, and checks in his/her baggage for issuance of tag RFID at the baggage check-in facility 16 (baggage check-in counter). Note that there is also a method in which the baggage is checked in beforehand. In the IT general information smart center 17, there are an airport general information center, travel agency, Internet room, etc. At the travel agency, the user can make change in the reservations, such as the airline ticket, travel schedule and various kinds of reservation data, pay for the travel expenses to the airport, confirm the contents, and prepare for check-in.

At the passenger check-in facility 12, check-in is made by verifying the person based on the passport card 1 and confirming the passenger ticket based on the passport card 1. For the verification of the person, the passport card 1 is inserted into the terminal device 30 (I/O device), a used language and drawing/voice are selected, and his/her finger or palm is placed on a finger print/palm print collator 20. In other words, the person is verified by biometric characteristics. Moreover, the image of the photograph of the face is displayed on a monitor to collate it with the face of the person. Here, the confirmation of the baggage tag is made, and the confirmation of the boarding seat number, etc. can also be made.

Subsequently, the user passes through the security facility 13 (security gate), and waits in the boarding information/waiting room 15 until the time of departure. At the security gate, in addition to detection of metal, the passage of the user through the gate may be also confirmed by the passport card 1 so as to grasp where the passenger is waiting. In the boarding information/waiting room 15, the payment for meals and shopping at snack bars, restaurants, tax-free shops, etc, can be made by the passport card 1, and cash advance services can also be used to have cash with this passport card 1.

For a departure inspection, the user inserts the passport card 1 into the terminal device 30 (I/O device) at the inspection gate of the departure inspection facility 14, selects a used language and drawing/voice, and answers the questions from the terminal device 30 (for example, “Is there anything to declare?”). If there is some problem, the gate is not open, and the inspector gives the user instructions. For the verification of the person, the user places his/her finger or palm on the finger print/palm print collator 20. In other words, the personal verification is made by biometric characteristics. Moreover, the image of the photograph of the face is displayed on a monitor to collate it with the face of the person.

The position after the passage through the departure inspection facility 14 or the location of the departure inspection facility 14 is a concourse, and the user passes through an automatic gate by inserting the passport card 1 into the terminal device 30 and enters the airplane. If the passport card 1 has a wireless function, the system may be designed to receive a wireless signal inside the airplane and guide the user to his/her seat using the display. Besides, if the passport card 1 has a display function, the system may be designed to display the seat information to obviate the need to carry the passenger ticket printed on paper.

For entry into the country, like the departure formalities, the user goes through the entry formalities including the personal verification based on the passport card 1, and, if necessary, an entry inspection based on the confirmation of flight, at the entry inspection facility 18 (entry inspection gate).

From the security point of view, the inspectors may check all the people entering into the country for their manipulating state, and the procedure is as follows.

Insert the passport card 1 into the terminal device 30.

Place a finger or palm on the finger print/palm print collator 20 connected to the terminal device 30 (personal verification by biometric characteristics).

Answer the questions from the terminal device 30 (for example, “Is there anything to declare?”).

An entry inspection is made by the system and, if entry is admitted, the gate is open for entry. The inspector displays the image of the photograph of the face on the monitor to collate it with the face of the person, and checks a suspicious person under this condition.

The process proceeds with a Customs officer according to instructions given by the terminal device 30 depending on the contents of declaration, and then the user passes through the gate for entry into the country.

Baggage is carried to a turntable 21 predetermined for the user's flight, based on the data of RFID (standard format) attached to the baggage at the time of departure. Even when a plurality of turntables 21 are used, each user's baggage is managed as a unit. The baggage is grouped for each turntable 21 according to transit, seats, other factor, and the information is displayed on a large display. If the passport card 1 has the wireless function and display function, the system may be designed to receive from the control system in the airport the information showing a turntable 21 to which the baggage is carried and display that information. Accordingly, the user can easily confirm the corresponding turntable 21 by the passport card 1 at hand without seeing the large display.

At the customs check facility 19, the user goes through a customs check by inserting the passport card 1 into the terminal device 30. In a check station 22, the terminal device 30 is placed as an automatic duty inspecting terminal, and the terminal device 30 obtains the baggage declaration card information from the passport card 1. Moreover, an automatic customs inspection card declaration inspection is made, and the tax is withdrawn from this passport card 1.

As described above, since the card system for immigration/emigration control of the present invention is designed to automatically perform the immigration/emigration control operation, security check operation and check-in operation at airports and seaports where the international lines depart or arrive, it is possible to quickly provide immigration/emigration control operations and services for a large number of passengers within the limited facility space. By adopting the card system for immigration/emigration control of the present invention, the space of the entry/departure inspection area is reduced because it is only necessary to place the terminal devices therein, and the check-in gate is not congested because there is no need to make contact.

There has been the following trend in the card system among the international organizations, airports and airlines. Specified objectives of the International Civil Aviation Organization (ICAO) established by Article 43 of the Convention of International Civil Aviation include: promotion of safe and orderly growth of international civil aviation throughout the world; encouragement of the development of airways, airports, and air navigation facilities for international civil aviation; and meeting the needs of the people of the world for safe, regular, efficient, and economical air transportation.

Under Article 37 of this convention, for international standards and recommended practices, contracting states agree to collaborate in securing the highest practicable degree of uniformity in regulations, standards, procedures, and organization in relation to aircraft, personnel, airways, and auxiliary services in all matters when uniformity will facilitate and improve air navigation. The contracting states have an obligation to follow the standards and recommended practices in principle, and, if a state can not follow the standards and recommended practices for a particular reason, that state must notify ICAO of the reason in advance. At present, no estrangement notification has been made, and all the contacting states obey the international standards and procedures.

The above-mentioned international standards and recommended practices for customs and immigration/emigration are specified in Annex 9, and Annex 9 includes the provisions on the issuance of passports as Recommendation 3.5.3. Since each contracting state contains necessary description in passports according to this recommendation, the contents of description are the same in all the contacting states. The recommended practices of Annex 9 specify that each contracting state bears the responsibility for adopting all possible measures, such as the promulgation of special rules, to facilitate and promote the operation of aircraft between the territories of the contacting states and especially prevent unnecessary delays for crewmembers, passengers and cargo, between the enforcement of laws related to immigration/emigration, public health, customs, and clearance.

Since 1997, ICAO allows each contracting state government to issue machine-readable crewmember certificate (CMC) cards to crewmembers of airplanes engaged in international navigation, and operation/cabin safety inspectors, according to Recommended Practice 3.25 provided by ICAO, and the crewmembers to use the CMC cards in place of the passports in passing through the customs and immigration/emigration in a foreign airport for entry into the contacting state. In recent years, as the means for ensuring convenience and security of an IC card system over a wide range, ICAO, International AIR Transport Association (IATA), the governments of the states, airports, airlines, etc. are trying hard to develop this card system, and similar chip techniques are being applied to both passports and a passenger ticket system, but chips have not yet been embedded in cards at this stage.

In order to rapidly process immigration/emigration control and customs formalities at airports and to achieve an objective to further develop an automatic passport reader according to ICAO's Recommended Practice 3.4.1, ICAO has presented the governments of the respective states the development plan of the government of each state to adopt the research and development of a card utilization system as the international standards and recommended practices. Moreover, in order to reduce the personnel expenses of the airlines and simplify a large number of costly operations such as the issuance of airline tickets, IATA is carrying out research and experiments on a smart travel/card system.

However, there is no probability of the integration of conventional card systems because of the individual purposes, while the present invention is characterized by being a comprehensive smart passport card that contains various kinds of data necessary for the security operations, the issuance of an airline ticket by an airline, automated check-in, a general information system in airports, the identification of a person, etc. as well as the customs and immigration/emigration operations, and has an integrated electronic settlement function applicable to land, air and sea transportations. Thus, at the present stage, the present invention is the first comprehensive smart passport card in the world.

As this invention may be implemented in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A card system for immigration/emigration control using a card having a passport function and an airline ticket function or ship ticket function to execute a departure inspection and/or entry inspection of a person carrying said card and check-in of the person for boarding an airplane or a ship.

2. The card system for immigration/emigration control of claim 1, comprising:
a first reader/writer, placed at a public organization who issues official certificates, for reading/writing data in said card; and
a second reader/writer, placed at a passport check station, for reading/writing data in said card.

3. The card system for immigration/emigration control of claim 2, comprising:
a first server to which said first reader/writer is to be connected and which stores official personal data about the person in a file; and
a second server to which said second reader/writer is to be connected and which stores the person's data about boarding on an airplane/ship in a file.

4. The card system for immigration/emigration control of claim 1,
wherein said card has a function as a credit card and enables the person to settle payment with said card.

5. The card system for immigration/emigration control of claim 4, comprising:
a first reader/writer, placed at a public organization who issues official certificates, for reading/writing data in said card;
a second reader/writer, placed at a passport check station, for reading/writing data in said card; and
a third reader/writer, placed at a commercial facility, for reading/writing data in said card.

6. The card system for immigration/emigration control of claim 5, comprising:
a first server to which said first reader/writer is to be connected and which stores official personal data about the person in a file;
a second server to which said second reader/writer is to be connected and which stores the person's data about boarding on an airplane/ship in a file; and
a third server to which said third reader/writer is to be connected and which stores the person's data about payment in a file.

7. A card system for immigration/emigration control, comprising:
a card having a memory storing data showing biometric characteristics to identify a person carrying said card, official personal data on the person, and the person's data about boarding on an airplane/ship;
a reader for reading data from said card;
departure/entry inspecting means for performing a departure inspection and/or entry inspection of the person, based on the data read from said card by said reader; and
boarding check-in means for executing check-in of the person for boarding an airplane or a ship, based on the data read from said card by said reader.

8. The card system for immigration/emigration control of claim 7,
wherein said departure/entry inspecting means comprises:
storing means for storing data showing biometric characteristics to identify the person and official personal data on the person; and collating means for collating the data showing biometric characteristics and the personal data on the person which are obtained from the person, with the data stored in said storing means and the data read from said card.

9. The card system for immigration/emigration control of claim 7,
wherein said boarding check-in means comprises: storing means for storing the person's data about boarding on an airplane/ship; and collating means for collating the data stored in said storing means with the data read from said card.

10. A card system for immigration/emigration control, comprising:
a card having a passport function and an airline ticket function or ship ticket function, and allowing writing/reading of data therein for effecting the functions;
a reader/writer for reading/writing data in said card;
departure/entry inspecting means for performing a departure inspection and/or entry inspection of a person carrying said card; and
boarding check-in means for executing check-in of the person for boarding an airplane or a ship.

11. The card system for immigration/emigration control of claim 10,
wherein said card has a function as a credit card, and said reader/writer reads/writes data in said card for effecting the credit function, and
said card system further comprises settlement means for settling payment of the person.

12. The card system for immigration/emigration control of claim 10,
wherein said reader/writer reads/writes data about acceptance/delivery of baggage of the person in said card, and
said card system further comprises baggage processing means for accepting/delivering baggage, based on data read from said card.

13. A card system for immigration/emigration control, comprising:
a card having a passport function and an airline ticket function or ship ticket function, and allowing writing/reading of data therein for effecting the functions;
a reader/writer for reading/writing data in said card; and
a controller to be connected to said reader/writer, and capable of performing the following operations:
(i) performing a departure inspection and/or entry inspection of a person carrying said card; and
(ii) executing check-in of the person for boarding an airplane or a ship.

14. The card system for immigration/emigration control of claim 13,
wherein said card has a function as a credit card, and said controller is capable of performing the following operation:
(iii) settling of payment of the person.

15. An immigration/emigration control process using a card having a passport function and an airline ticket or ship ticket function, comprising the steps of
performing a departure inspection and/or entry inspection of a person carrying said card; and
executing check-in of the person for boarding an airplane or a ship.

16. The immigration/emigration control process of claim 15,
wherein said card has a function as a credit card, and payment of the person is settled with said card.

17. A card for use in departing or entering a country,
wherein said card has a passport function and an airline ticket or ship ticket function, and data about a person carrying said card, which is used for a departure inspection and/or entry inspection of the person and check-in of the person for boarding an airplane or a ship, is written in/read from said card.

18. The card of claim 17,
wherein said card has a function as a credit card, and data used for settlement of payment of the person is written in/read from said card.

19. The card of claim 17,
wherein an image of a photograph of the person is loaded in said card.

20. The card of claim 17,
wherein said card has a first memory area where writing/reading of data by the person is prohibited, and a second memory area where writing/reading of data by the person is allowed.

21. The card of claim 17,
wherein said card has a function as a search card for searching for guide information in airports or seaports.

22. The card of claim 17,
wherein said card has a memory area in/from which data about acceptance/delivery of baggage of the person is written/read.
